(19) United States
(12) Patent Application Publication
(10) Pub. No.: US 2019/0164066 A1
(43) Pub. Date: May 30, 2019

(54) DYNAMIC RUN-TIME CORPUS BUILDER

(71) Applicant: INTERNATIONAL BUSINESS MACHINES CORPORATION, Armonk, NY (US)

(72) Inventors: Charles E. Beller, Baltimore, MD (US); Yashavant Singh, Ashburn, VA (US); Palani Sakthi, Palatine, IL (US); Richard Lee Darden, Leesburg, VA (US)

(21) Appl. No.: 15/825,742

(22) Filed: Nov. 29, 2017

(51) Int. Cl. G06N 5/02; G06F 17/30

(52) U.S. Cl. CPC G06N 5/022; G06F 17/30979

(57) ABSTRACT

The present invention may include an embodiment to improve the performance (both response time and quality of answers) of a knowledge based service operating on a master catalog of data by dynamically building a narrowed, focused, and reduced corpus of data over which the knowledge based service operates. The embodiment may identify a corpus catalog for a knowledge base service, where the knowledge base service includes one or more documents. Then the embodiment may determine one or more subjects based on profile preferences of a user and determining the one or more documents corresponding to the determined one or more subjects based on determining the one or more subjects were updated. The embodiment may stage the determined one or more documents in a master corpus, where the master corpus is a subset of the corpus catalog and upload the master corpus to the knowledge base service.

### STATEMENT REGARDING FEDERALLY SPONSORED RESEARCH OR DEVELOPMENT

This invention was made with Government support. The Government has certain rights in this invention.

### BACKGROUND

The present invention relates, generally, to the field of computing, and more particularly to a knowledge base service configuration and management.

A knowledge base is a technology used to digitally store complex structured and unstructured information used by a computing system. Typically, the knowledge base service is used in connection with an expert system which is configured to represent facts about the world and an inference engine that can reason about those facts and use rules and other forms of logic to deduce new facts or highlight inconsistencies. For example, a knowledge base may be IBM Watson® (IBM Watson and all IBM Watson-based trademarks and logos are trademarks or registered trademarks of International Business Machines Corporation and/or its affiliates).

IBM Watson® is based on a knowledge base service designed for question answering that may have the capabilities to apply advanced natural language processing, information retrieval, knowledge representation, automated reasoning, and machine learning technologies to the field of open domain question answering. The question answering technology is different from a document search technology by that document search takes a keyword query and returns a list of documents, ranked in order of relevance to the query typically based on popularity and page ranking, while question answering technology takes a question expressed in a natural language, seeks to understand it in much greater detail, and returns a precise answer to the question. Typically, the precise answer to the question is based on different techniques that are used to analyze natural language, identify sources, find and generate hypotheses, find and score evidence, merge and rank hypotheses, and pick the hypothesis with a highest rank as the precise answer.

### SUMMARY

According to one embodiment, a method, computer system, and computer program product for a dynamic run-time corpus builder is provided to improve the performance (both response time and quality of answers) of a knowledge based service operating on a master catalog of data, by dynamically building a narrowed, focused, and reduced corpus of data over which the knowledge based service operates. The embodiment may identify a corpus catalog for a knowledge base service, where the knowledge base service includes one or more documents. Then the embodiment may determine one or more subjects based on profile preferences of a user and determining the one or more documents corresponding to the one or more determined subjects based on determining the one or more subjects were updated. The embodiment may stage the determined one or more documents in a master corpus, where the master corpus is a subset of the corpus catalog and upload the master corpus to the knowledge base service.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a dynamic run-time corpus builder process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to a knowledge base service configuration and management. The following described exemplary embodiments provide a system, method, and program product to, among other things, perform a scalable deployment of a knowledge base system based on user profile data. Therefore, the present embodiment has the capacity to improve the technical field of knowledge base service configuration and management by reducing the size of a knowledge base system and increasing the efficiency of the knowledge base system by hosting only a relevant to the user environment. Additionally, the present embodiment may improve the performance (both response time and quality of answers) of a knowledge based service operating on a master catalog of data, by dynamically building a narrowed, focused, and reduced corpus of data over which the knowledge based service operates.

As previously described, knowledge base service is a technology used to digitally store complex structured and unstructured information used by a computing system. Typically, the knowledge base is used in connection with an expert system which is configured to represent facts about the world and an inference engine that can reason about those facts and use rules and other forms of logic to deduce new facts or highlight inconsistencies. For example, a knowledge base service may be IBM Watson® (IBM Watson and all IBM Watson-based trademarks and logos are trademarks or registered trademarks of International Business Machines Corporation and/or its affiliates).

Typically, a knowledge base system requires ingesting all available documents for each instance of use where each document may include text, voice or other multimedia content. If there are multiple users who use the knowledge base system, two instances that include all the available documents are required for each one of the users despite the instances being required in different fields of interest. For example, if a knowledge base service is a news knowledge base and one of the users is interested in financial news while the other focuses on sports two entire corpuses of a whole knowledge base are used for each user. In addition, if there are new documents that are dynamically added to the corpus all the queries have to be repeated with an updated corpus as a whole in order for the system to produce reliable results. As such, it may be advantageous to, among other things, implement a system that analyzes a user profile and ingesting to a master corpus that is only relevant to the user profile knowledge base documents without duplicating the same corpus for each user.

According to one embodiment, a dynamic run-time corpus builder program may perform a scalable deployment of a knowledge base system based on a user profile data. The scalable deployment may be performed by determining one or more subjects that the user is interested in based on the user profile data collected during previous usage of the knowledge base system. After determining the one or more subjects, the dynamic run-time corpus builder program may use the one or more subjects to generate a scalable master corpus that includes one or more documents related to the one or more subjects.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to dynamically create a master corpus from an ingested document based on a user profile.

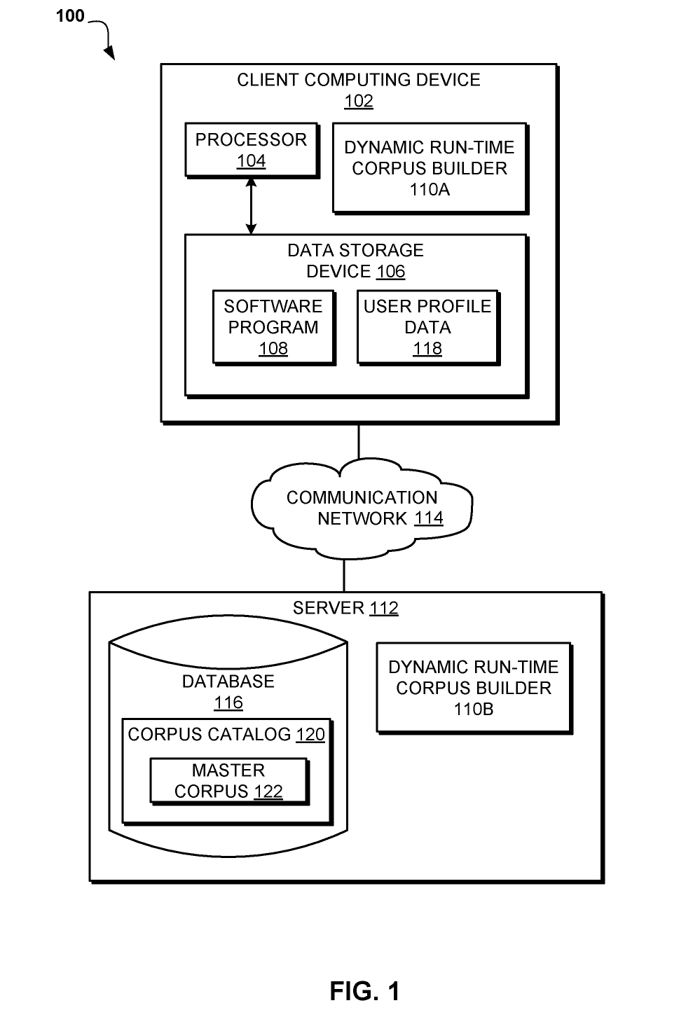

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

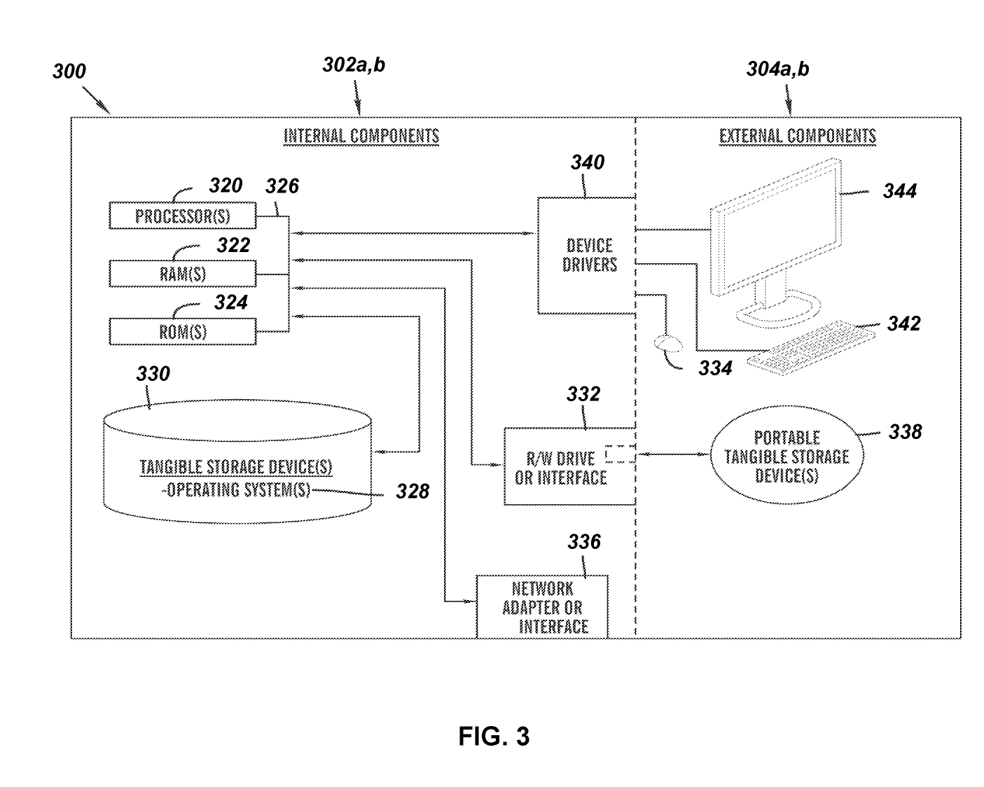

Client computing device 102 may include a processor 104 and a data storage device 106 that is enabled to host and run a software program 108, user profile data 118, and a dynamic run-time corpus builder (DRTCB) program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively. The user profile data 118 may be a database that may include data related to user usage of a knowledge base, such as recent questions or queries searched by the user on the knowledge base platform, a subject of a search, a time of a search, and one or more indexes representing the corresponding one or more fields that the user is interested in.

The server computer 112 may be a laptop computer, netbook computer, personal computer (PC), a desktop computer, or any programmable electronic device or any network of programmable electronic devices capable of hosting and running a DRTCB program 110B and a database 116 and communicating with the client computing device 102 via the communication network 114, in accordance with embodiments of the invention. The database 116 may be configured to host and run corpus catalog 120 and master corpus 122. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud. The corpus catalog 120 may be one or more documents that were previously stored or received by the server 112 via communication network 114 in response to a user accessing a knowledge base platform or in response to new documents that are ingested to the knowledge base. The master corpus 122 may be a dynamically changing subset of the corpus catalog 120 based on a user profile.

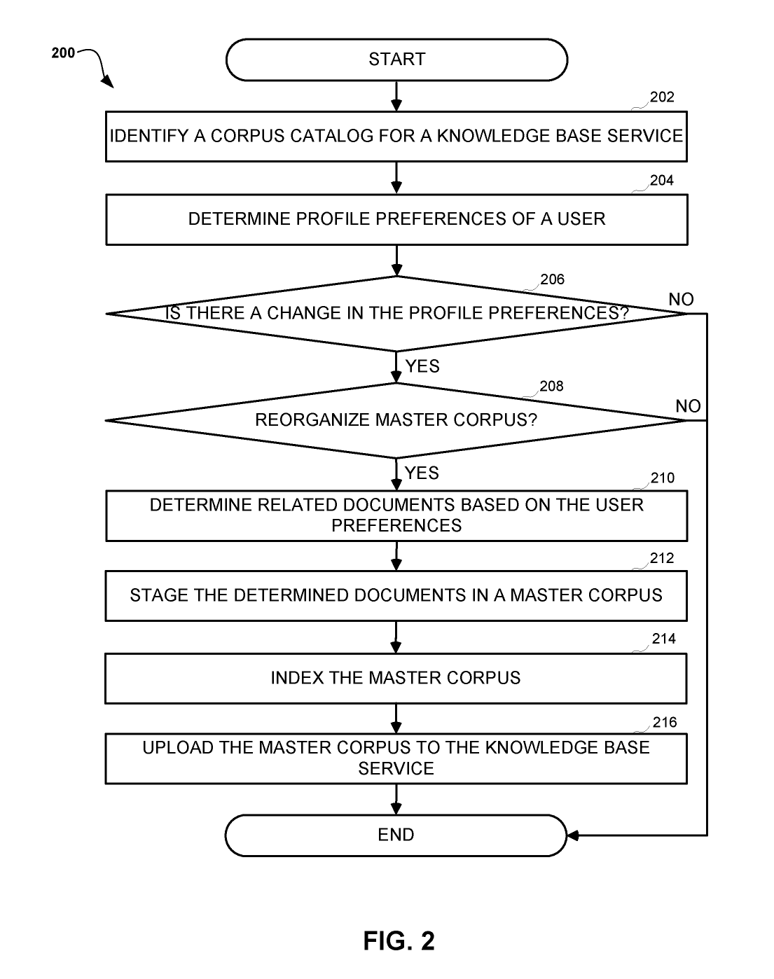

According to the present embodiment, the DRTCB program 110A, 110B may be a program capable of analyzing a profile of the user and ingesting documents from the corpus catalog that have a same subject determined from a user profile into a master corpus, without duplicating the same corpus catalog for each one of the users of the knowledge base service. The dynamic run-time corpus builder method is explained in further detail below with respect to FIG. 2.

Referring now to FIG. 2, an operational flowchart illustrating dynamic run-time corpus builder process 200 is depicted according to at least one embodiment. At 202, the DRTCB program 110A, 110B identifies a corpus catalog 120 for a knowledge base service. According to at least one embodiment, DRTCB program 110A, 110B may ingest information containing documents, databases, text, and multimedia content based on a user general preferences and organize them in a corpus catalog 120. For example, if a user is interested in a news knowledge base the DRTCB program 110A, 110B may access all the news websites available online via communication network 114 download the information, and rearrange all the downloaded information in corpus catalog 120. In addition, DRTCB program 110A, 110B may create an index during identification, where each subject determined in the corpus catalog 120 is associated with a value during indexing of the corpus catalog 120.

Next, at 204, the DRTCB program 110A, 110B determines profile preferences of a user. According to at least one embodiment, DRTCB program 110A, 110B may access user profile data 118 that is associated with the user using the knowledge base services, and analyze recent user preferences including last search queries. For example, user profile data 118 may include an index or a query related to immigration and therefore, DRTCB program 110A, 110B may infer that the main topic the user is interested in is immigration news.

Then, at 206, the DRTCB program 110A, 110B determines whether there is a change in the profile preferences. According to at least one embodiment, DRTCB program 110A, 110B may analyze the subject of recent queries made by the user and compare the last query with the previous queries whether they are in the same subject, such as related to an immigration. In another embodiment, a user may update the field of his interest while accessing user profile data 118. In a further embodiment, a user may manually select to reorganize the master corpus that may cause the DRTCB program 110A, 110B to proceed as if the profile preferences were changed. If the DRTCB program 110A, 110B determines that there is a change in the profile preferences (step 206, “YES” branch), the DRTCB program 110A, 110B may continue to step 208 to reorganize master corpus. If the DRTCB program 110A, 110B determines that there are no changes in the profile preferences (step 206, “NO” branch), the DRTCB program 110A, 110B may terminate.

Then, at 208, the DRTCB program 110A, 110B may determine whether to reorganize the master corpus. According to at least one embodiment, the DRTCB program 110A, 110B may ask for an instruction from the user of a knowledge base whether the user wants to reorganize master corpus 122. In another embodiment, reorganizing the master corpus by the DRTCB program 110A, 110B may be optional and based on a user preference. If the DRTCB program 110A, 110B receives an instruction to reorganize master corpus 122 (step 208, “YES” branch), the DRTCB program 110A, 110B may continue to step 210 to determine related documents based on the user preferences. If the DRTCB program 110A, 110B determines that there are no changes in the profile preferences (step 208, “NO” branch), the DRTCB program 110A, 110B may terminate.

Next, at 210, the DRTCB program 110A, 110B determines related documents based on the user preferences. According to at least one embodiment, the DRTCB program 110A, 110B may convert the user profile data 118 to one or more values associated with the one or more subjects identified in the profile preferences and by matching the one or more values to the corresponding values in the corpus catalog 120 associated with one or more documents, determine the related one or more documents, text, and multimedia content files stored in the corpus catalog 120. For example, when an immigration subject is associated with an index representing immigration news in the indexing of the corpus catalog 120 by the DRTCB program 110A, 110B, and the DRTCB program 110A, 110B determined that this is a main subject of the interest from the user profile data 118, then the DRTCB program 110A, 110B may determine all the documents from the corpus catalog 120 that are associated with the index.

Next, at 212, the DRTCB program 110A, 110B stages the determined documents in a master corpus. According to at least one embodiment, the DRTCB program 110A, 110B may stage the one or more documents determined in step 210 in a master corpus 122 in a hierarchical order compatible with the knowledge base requirements. To continue our previous example, if the user main subject is immigration news having an internal index 12, the DRTCB program 110A, 110B may copy all the documents from corpus catalog 120 to master corpus 122, and index all documents in a database compatible with the knowledge base service.

Next, at 214, the DRTCB program 110A, 110B indexes the master corpus. According to at least one embodiment, the DRTCB program 110A, 110B may index the master corpus 122, such as by associating the content of the master corpus 122 with the one or more values representing the one or more subjects and relations between the content parts, subjects and dates the content was created or added by using known techniques, such as by Natural Language Processing (NLP) and word embedding. To continue our previous example, after creating the master corpus 122 that includes all the subjects that a user is interested in, the DRTCB program 110A, 110B may index them, convert the multimedia files to a text using NLP, and create additional indexing based on a word embedding, such as determining that the subjects are related using word embedding and assigning to the subjects a corresponding index value.

Next, at 216, the DRTCB program 110A, 110B uploads the master corpus to the knowledge base service. According to at least one embodiment, DRTCB program 110A, 110B may upload the indexed master corpus 122 to the knowledge base server, such as server 112 and make it available for the user. In another embodiment, DRTCB program 110A, 110B may send the indexed master corpus 122 to a client computing device 102 for local execution.

It may be appreciated that FIG. 2 provides only an illustration of one implementation and does not imply any limitations with regard to how different embodiments may be implemented. Many modifications to the depicted environments may be made based on design and implementation requirements. For example, the master corpus may be updated during run time based on determining the newly added documents share the same one or more subjects determined from the profile preferences without interrupting the service of the knowledge base server.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the DRTCB program 110A in the client computing device 102, and the DRTCB program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the DRTCB program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the DRTCB program 110A in the client computing device 102 and the DRTCB program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the DRTCB program 110A in the client computing device 102 and the DRTCB program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

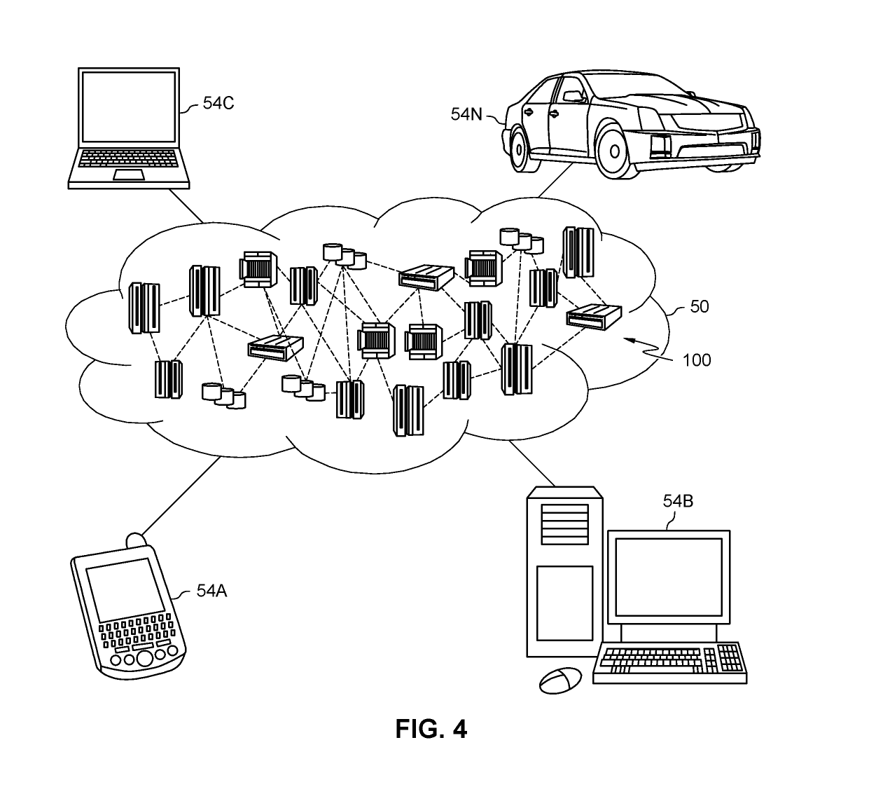

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

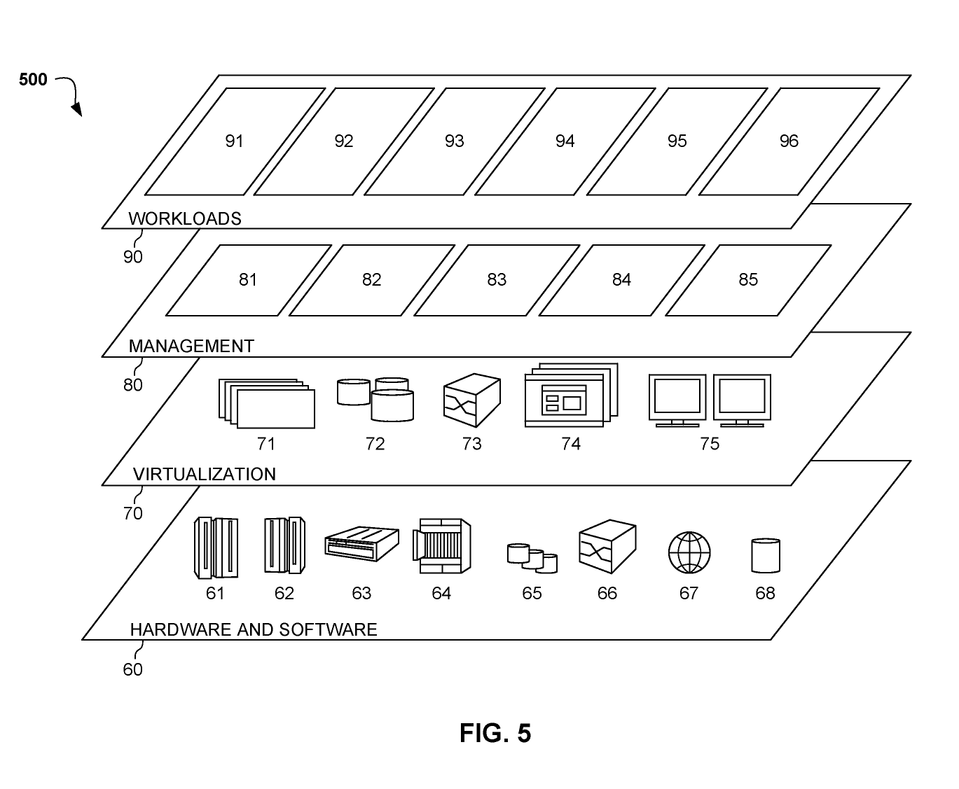

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic run-time corpus building 96. Dynamic run-time corpus building 96 may relate to identifying user search preferences based on the user profile data and generating a master corpus that is based on the user profile data.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for a dynamic run-time corpus builder, the method comprising:
identifying a corpus catalog for a knowledge base service;
determining one or more subjects based on profile preferences of a user;
based on determining the one or more subjects were updated, determining one or more documents corresponding to the determined one or more subjects;
staging the determined one or more documents in a master corpus, wherein the master corpus is a subset of the corpus catalog; and
uploading the master corpus to the knowledge base service.

2. The method of claim 1, wherein determining one or more subjects based on profile preferences of a user further comprises:
identifying one or more user profile preferences by accessing a plurality of user profile data wherein the user profile data comprises one or more search queries, a date of each search query and a time of each search query; and
determining the one or more subjects based on analyzing the one or more search queries.

3. The method of claim 2, wherein determining the one or more subjects were updated is based on comparing the date and time of the each search query.

4. The method of claim 1, wherein staging the determined one or more documents in a master corpus comprises:
associating the one or more documents corresponding to the determined one or more subjects with the master corpus; and
indexing the one or more documents corresponding to the determined one or more subjects.

5. The method of claim 1, wherein the processor-implemented method for a dynamic run-time corpus builder is executed during a run time of the knowledge base service.

6. The method of claim 1, wherein the knowledge base service is a system configured to represent one or more facts and an inference engine that reasons about the one or more facts and uses one or more rules and one or more other forms of logic to deduce the one or more facts.

7. The method of claim 1, wherein the corpus catalog comprises one or more documents related to a field, wherein the field is identified in the one or more user profile preferences.

8. A computer system for a dynamic run-time corpus builder, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a corpus catalog for a knowledge base service;
determining one or more subjects based on profile preferences of a user;
based on determining the one or more subjects were updated, determining one or more documents corresponding to the determined one or more subjects;
staging the determined one or more documents in a master corpus, wherein the master corpus is a subset of the corpus catalog; and
uploading the master corpus to the knowledge base service.

9. The computer system of claim 8, wherein determining one or more subjects based on profile preferences of a user further comprises:
identifying one or more user profile preferences by accessing a plurality of user profile data wherein the user profile data comprises one or more search queries, a date of each search query and a time of each search query; and
determining the one or more subjects based on analyzing the one or more search queries.

10. The computer system of claim 9, wherein determining the one or more subjects were updated is based on comparing the date and time of the each search query.

11. The computer system of claim 8, wherein staging the determined one or more documents in a master corpus comprises:
associating the one or more documents corresponding to the determined one or more subjects with the master corpus; and
indexing the one or more documents corresponding to the determined one or more subjects.

12. The computer system of claim 8, wherein the processor-implemented method for a dynamic run-time corpus builder is executed during a run time of the knowledge base service.

13. The computer system of claim 8, wherein the knowledge base service is a system configured to represent one or more facts and an inference engine that reasons about the one or more facts and uses one or more rules and one or more other forms of logic to deduce the one or more facts.

14. The computer system of claim 8, wherein the corpus catalog comprises one or more documents related to a field, wherein the field is identified in the one or more user profile preferences.

15. A computer program product for a dynamic run-time corpus builder, the computer program product comprising:
one or more computer-readable tangible storage medium and program instructions stored on at least one of the one or more tangible storage medium, the program instructions executable by a processor, the program instructions comprising:
program instructions to identify a corpus catalog for a knowledge base service;
program instructions to determine one or more subjects based on profile preferences of a user;
based on program instructions to determining the one or more subjects were updated, program instructions to determine one or more documents corresponding to the determined one or more subjects;
program instructions to stage the determined one or more documents in a master corpus, wherein the master corpus is a subset of the corpus catalog; and
program instructions to upload the master corpus to the knowledge base service.

16. The computer program product of claim 15, wherein program instructions to determine one or more subjects based on profile preferences of a user further comprises:
program instructions to identify one or more user profile preferences by accessing a plurality of user profile data wherein the user profile data comprises one or more search queries, a date of each search query and a time of each search query; and
program instructions to determine the one or more subjects based on analyzing the one or more search queries.

17. The computer program product of claim 16, wherein program instructions to determine the one or more subjects were updated is based on comparing the date and time of the each search query.

18. The computer program product of claim 15, wherein program instructions to stage the determined one or more documents in a master corpus comprises:
program instructions to associate the one or more documents corresponding to the determined one or more subjects with the master corpus; and
program instructions to index the one or more documents corresponding to the determined one or more subjects.

19. The computer program product of claim 15, wherein the processor-implemented method for a dynamic run-time corpus builder is executed during a run time of the knowledge base service.

20. The computer program product of claim 15, wherein the knowledge base service is a system configured to represent one or more facts and an inference engine that reasons about the one or more facts and uses one or more rules and one or more other forms of logic to deduce the one or more facts.
